(19) United States
(12) Patent Application Publication
(10) Pub. No.: US 2018/0326840 A1
(43) Pub. Date: Nov. 15, 2018

(54) APPARATUS FOR REDUCING HYDROCARBON EMISSIONS FROM VEHICLES

(71) Applicant: Tho Truong Huynh, Chilworth, Southampton (GB)

(72) Inventor: Tho Truong Huynh, Chilworth, Southampton (GB)

(21) Appl. No.: 15/773,900

(22) PCT Filed: Nov. 4, 2016
(86) PCT No.: PCT/GB2016/053431

§ 371 Date: May 4, 2018

(30) Foreign Application Priority Data
Nov. 6, 2015 (GB) 1519619.9

(51) Int. Cl. B60K 15/035; B67D 7/04; F02M 25/08

(52) U.S. Cl. CPC B60K 15/03504; B67D 7/048; B60K 2015/03514; F02M 25/089; F02M 25/0854

(57) ABSTRACT

An apparatus for reducing hydrocarbon emissions from vehicles is disclosed, wherein the apparatus includes a first chamber, a second chamber, and an inlet which, in use, allows vapor from a fuel tank to be introduced into the first chamber, characterized by a distributor which distributes vapor from the fuel tank in the first chamber.

### CROSS-REFERENCE TO RELATED APPLICATIONS/INCORPORATION BY REFERENCE STATEMENT

This application is a US national stage application filed under 35 USC § 371 of International Application No. PCT/GB2016/053431, filed Nov. 4, 2016; which claims priority to UK App No. GB1519619.9, filed Nov. 6, 2015. The entire contents of the above-referenced patent applications are hereby expressly incorporated herein by reference.

### TECHNICAL FIELD

The disclosure relates to an apparatus for reducing hydrocarbon emissions from vehicles and, more particularly but not exclusively, to an apparatus for reducing hydrocarbon emissions from fuel tanks.

### BACKGROUND

Historically hydrocarbon vapours from the fuel tank of a vehicle were emitted into the environment through venting without any filtering. This was damaging to the environment and certain legal limits were imposed on the hydrocarbon emissions of all vehicles.

Nowadays vehicles are fitted with apparatus which reduces the hydrocarbon emissions to keep them below the local legal limit.

Fuel evaporates within the fuel tank of a vehicle, particularly when the vehicle is exposed to high temperatures (such as when in direct sunlight) and stationary or idling in traffic. In order to reduce the emissions to the surrounding environment the fuel vapours from the fuel tank pass through vent lines to an apparatus comprising a chamber containing carbon granules (which term includes carbon pellets) where some of the hydrocarbon vapours are absorbed. This is known in the art as “loading”.

During loading operation, as the vapour from the fuel tank passes through the chamber the hydrocarbons in the vapour are adsorbed onto the surfaces of carbon granules contained within the apparatus. This reduces the amount hydrocarbons that are released into the atmosphere.

When the engine is running there is a vacuum in the inlet manifold. When the vacuum is sufficient an engine control module opens a solenoid purge value and a solenoid vent value. Ambient air is drawn through the apparatus. This desorbs the hydrocarbons, which are drawn into the inlet manifold and then into the combustion chambers of the piston. This is referred to as “purging” or “unloading”. Typically the vacuum in the inlet manifold is highest when the engine is idling. Until recently existing apparatus have been quite satisfactory.

In more recent times it is becoming common for engine control modules to switch the engine off if the vehicle is stationary for more than a few seconds. This fuel saving mode is known as a stop-start system. This results in an insufficient purging (regeneration) process, leading to a lack of working capacity in the carbon granules within the apparatus (the contained carbon commonly known as the carbon bed) and allows hydrocarbons to be emitted to the environment. This is referred to “hydrocarbon breakthrough”.

Our research has indicated that hydrocarbon breakthrough occurs in prior art apparatus even though the carbon granules are not all saturated with hydrocarbons. The present disclosure attempts, at least in certain non-limiting embodiments, to better utilize the adsorption capacity of the adsorbent.

The present disclosure provides an apparatus for reducing hydrocarbon emissions from vehicles, which apparatus comprises a first chamber for accommodating an adsorbent, a second chamber for accommodating an adsorbent, and an inlet which, in use, allows vapour from a fuel tank to be introduced into the first chamber, characterised by a distributor which, when the apparatus is in use and the first chamber and the second chamber contain adsorbent, and the inlet is connected to a fuel tank, distributes vapour from the fuel tank generally uniformly over a major portion of the surface of the adsorbent in the first chamber.

Optionally the distributor comprises a channel. This may aid vapour flow around the top portion of the apparatus.

Optionally the channel comprises slots. This can aid the fuel vapour to flow from the channel substantially evenly over the top surface of the carbon.

Optionally the slots are positioned above the base of the channel. This may allow the channel to provide a liquid trap and can inhibit liquid fuel from coming into contact with the adsorbent. The slots may not all be at the same height in the channel. The position of the slots in the channel can vary in all three dimensions.

Optionally the slots increase in size progressively as they move away from the inlet around the channel. In certain circumstances this facilitates a substantially even distribution of the fuel vapour into the carbon of the first chamber. The size of the slots may be uniform across all or some of the slots in the apparatus. The slots may be rectangular in cross section, this can provide a better vapour flow. The slots may be circular, elliptical, square or triangular in cross section, or any suitable shape.

Optionally the channel is provided with at least one shield. The shield may inhibit any liquid from passing through the slot.

Optionally the at least one shield protects at least one slot. There may be one single shield that runs around the channel that inhibits liquid from passing through at least one slot.

Optionally the channel comprises at least one web support. This can support the channel, in particular the sides of the channel. The channel may be fixed to the apparatus through the web support. There can be provided a single web support that is fixed between the channel and a screen holder and runs around the entire perimeter of the channel. Alternatively the web support or supports could run around the perimeter of part of the channel.

Optionally the channel is provided with at least one baffle which may be positioned within the channel. The at least one baffle can be positioned on the base of the channel. The arrangement of the at least one baffle could be along the centre line of the base of the channel, or offset, or both. The arrangement of the at least one baffle may be so that they are provided on the centre line of the channel and further baffles are provide in between the centre line baffles, so that the further baffles extend from both sides or one side of the channels towards the centre line. This can reduce sloshing of any liquid within the channel.

Optionally the channel comprises at least one dimple, which may inhibit, in use, the free flow of liquid therealong. The dimple may be positioned within the channel. The dimple may be positioned on the base of the channel. This can reduce sloshing of any liquid within the channel.

Optionally the base of the channel is impervious to liquid fuel. This may allow the channel to provide a liquid trap and can inhibit liquid fuel from coming into contact with the adsorbent.

Optionally at least one slot is defined by a recess in the top of the channel. A slot may be defined by a recess in the channel. A slot may be defined by, for example a recess in the top of the channel and the apparatus directly above the channel (the body of the apparatus); a recess in the body of the apparatus, and the channel; and/or a recess in the body of the apparatus and a recess in the channel.

Optionally the distributor comprises a perforate disk, or perforate plate. These may be of any appropriate shape or size. The perforation may be of any suitable shape or sizes and arranged randomly, periodically, or in any suitable form. The perforation may not be of a uniform shape or size and may be larger in size in certain areas or a certain area on the distributor to facilitate the desired generally uniform distribution.

Optionally the second chamber resides within the first chamber. The second chamber may partially reside within the first chamber.

Optionally the second chamber is offset from the centre of the first chamber. This can allow a more cost effective and simpler manufacturing process.

Optionally at least one side of the second chamber is in contact with at least one side of the first chamber.

Optionally at least one outer side of the second chamber is in contact with at least one inner side of the first chamber.

Optionally the second chamber may extend out of the boundary of the first chamber.

The present disclosure also provides an apparatus for reducing hydrocarbon emissions from vehicles, which apparatus comprises a first chamber for accommodating an adsorbent and a second chamber for accommodating an adsorbent, characterised in that the second chamber resides within the first chamber and the second chamber is offset from the centre of the first chamber.

Optionally the at least one side of the second chamber is in contact with at least one side of the first chamber.

Optionally the at least one outer side of the second chamber is in contact with at least one inner side of the first chamber.

Optionally the second chamber may extend out of the boundary of the first chamber.

Optionally the horizontal cross section of the first chamber and/or the second chamber is substantially rectangular.

Optionally the first and second chambers are formed during a single injection moulding apparatus.

The present disclosure also provides a vehicle having a fuel tank connected to an apparatus in accordance with the present disclosure.

### BRIEF DESCRIPTION OF THE DRAWINGS

Further features, aspects, and advantages of the present disclosure shall now be described with reference to the figures of the enclosed drawings.

FIG. 1 is a side view in vertical cross section of a prior art apparatus for reducing hydrocarbon emissions from vehicles during loading;

FIG. 2 is a side view in vertical cross section of one embodiment of an apparatus in accordance with the present disclosure in its operational orientation and during loading;

FIG. 3 is an enlarged view of a portion of FIG. 2;

FIG. 4 is a view similar to FIG. 3 showing 3 extra separate and distinct features;

FIG. 5 is top view in horizontal cross section through the top portion of a second embodiment of an apparatus in accordance with the present disclosure; and

FIG. 6 is a side view in vertical cross section along line VI-VI of FIG. 5 during loading.

### DETAILED DESCRIPTION

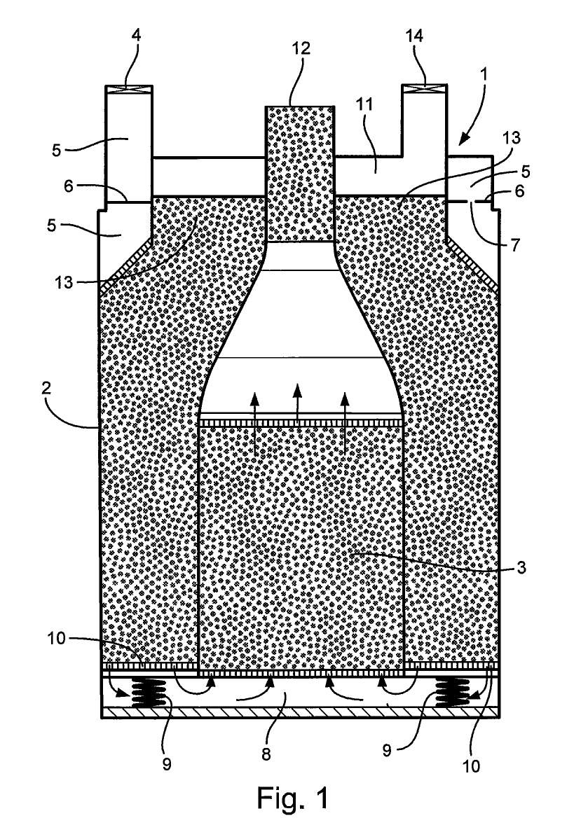

Referring to FIG. 1, which is based on WO 2014/082899, there is shown an apparatus for reducing hydrocarbon emissions from vehicles. The apparatus, which is generally identified by reference numeral 1, comprises a first chamber 2 and a second chamber 3, which is disposed concentrically within the first chamber 2. Both chambers 2 and 3 contain activated carbon granules and both chambers 2 and 3 are circular in horizontal cross section.

In use fuel vapour from the fuel tank (not shown), passes through an inlet 4 and into a chamber 5. The chamber 5 is separated into an upper portion and a lower portion by a ring 6. The fuel vapour flows around the upper portion of the chamber 5 and downwardly through a slot 7 in the ring 6 into the lower portion of the chamber 5. The slot 7 subtends an angle of about 30° around the circular perimeter of the apparatus 1. The hydrocarbon vapour flows around the lower portion of the chamber 5 and into the carbon granules in the first chamber 2, where hydrocarbons are adsorbed (known as loading).

The carbon granules are retained within the first chamber 2 and the second chamber 3 by various screens that are permeable to vapour. An air space 8 at the bottom of the apparatus 1 allows vapour to move between the first chamber 2 and the second chamber 3. The apparatus is sealed upon assembly and springs 9 and a plate 10 hold the contents of the apparatus 1 in place.

During purging a vacuum from the inlet manifold of the engine (not shown) is applied to a purge chamber 11. This draws air downwardly through a vent 12, into the second chamber 3 and through into the first chamber 2. The hydrocarbons undergo desorption from the carbon granules in both the first chamber 2 and the second chamber 3 and are drawn with the air through a purge buffer 13, through the purge chamber 11 and out via a purge valve 14 to be burnt in the engine (not shown).

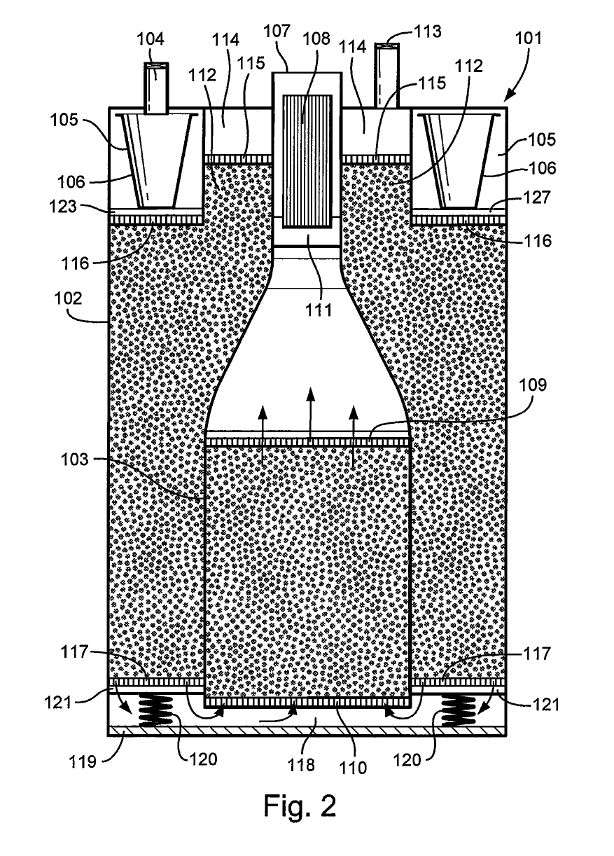

Referring to FIG. 2, there is shown an apparatus for reducing hydrocarbon emissions from vehicles in accordance with a first embodiment of the present disclosure. The apparatus, which is generally identified by reference numeral 101, comprises a first chamber 102 and a second chamber 103, which is within the first chamber 102. Both the first chamber 102 and the second chamber 103 contain carbon granules and both chambers 2 and 3 are circular in horizontal cross section. Reference will be made to carbon granules throughout, however carbon pellets may also be used as a substitute.

The apparatus 101 further comprises an inlet 104 and a distribution chamber 105 containing a distributor in the form of a channel 106, which extends around the distribution chamber 105. The apparatus 101 further comprises a vent 107 and a carbon monolith 108 within the upper portion of the second chamber 103. The carbon granules in the second chamber 103 fill only the lower portion of that chamber 103 and are retained by screen 109 and screen 110 which are permeable to vapour. The carbon monolith 108 is held in place with a support 111.

A purge buffer 112 containing carbon granules is in series with the carbon granules in the first chamber 101. The purge buffer 112 is separated from a purge valve 113 by a purge chamber 114 and a screen 115 that lays on top of the purge buffer 112.

The carbon granules in the first chamber 101 are retained by screen 116 and screen 117.

The bottom of both the first chamber 102 and the second chamber 103 are connected by an air space 118, which allows fuel vapour to move between the first chamber 102 and the second chamber 103. In assembly a base 119 is fitted to the bottom of the first chamber 103 which seals the apparatus 101. Springs 120 and a plate 121 are also provided to hold the components of the apparatus 101 in place.

As better seen in FIG. 3, slots 122 are provided in the arrangement of the channel 106 within the distribution chamber 105. The slots 122 are arranged periodically around the channel 106 and between the top of the sides of the channel 106 and the ceiling of the distribution chamber 105. The slots 122 penetrate through the channel 106 and the slots 122 are typically rectangular in shape, however could be circular or any shape.

The slots 122 are not of uniform size. In particular, they increase in length progressively as they move away from the inlet 104 around the channel 106. Alternatively the slots 122 could be of uniform size, or they could be of uniform size and the density of the slots 122 could increase as they move away from the inlet 104 around the channel 106. The slots 122 could be formed form a recess in the channel 106 and the ceiling of the distribution chamber 105, or a recess in the ceiling of the distribution chamber 105 and the channel 106, or a recess in both the ceiling of the distribution chamber 105 and in the channel 106.

The channel 106 sits upon a screen holder 123 of which it may be fixed thereon, alternatively the channel 106 and the screen holder 123 may be a single piece. The screen 116 is held in place by the screen holder 123, so that the screen 116 is in direct contact with the carbon granules and retains them within the first chamber 102.

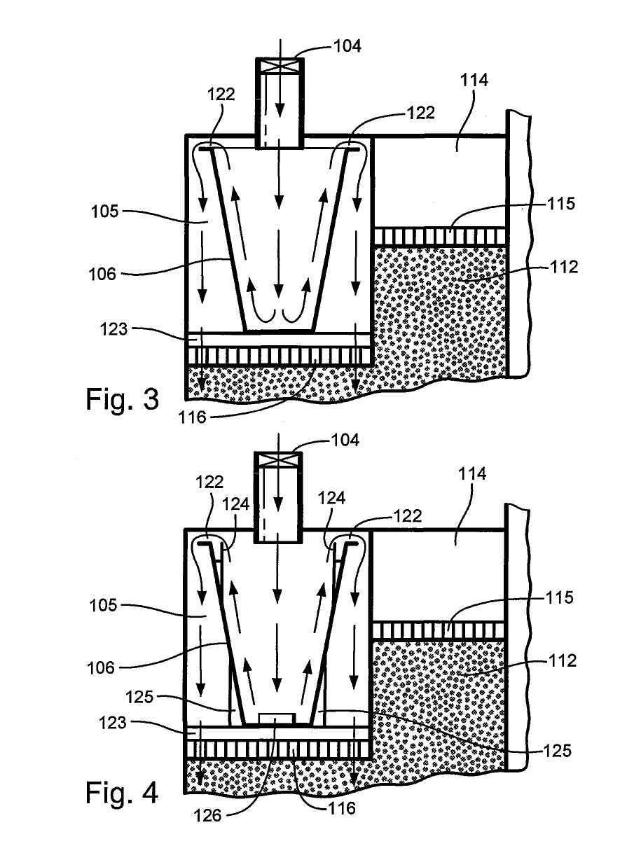

As better shown in FIG. 4, the channel 106 is provided with the following optional separate and distinct features. These include:

Shields 124 provided on the inside of the sides of the channel 106 in front of the slots 122;

Web supports 125 on the sides of the channel 106, which depend down and rest on the screen holder 123. These could be at periodic intervals around the channel 106 or comprise a single continuous web support; and

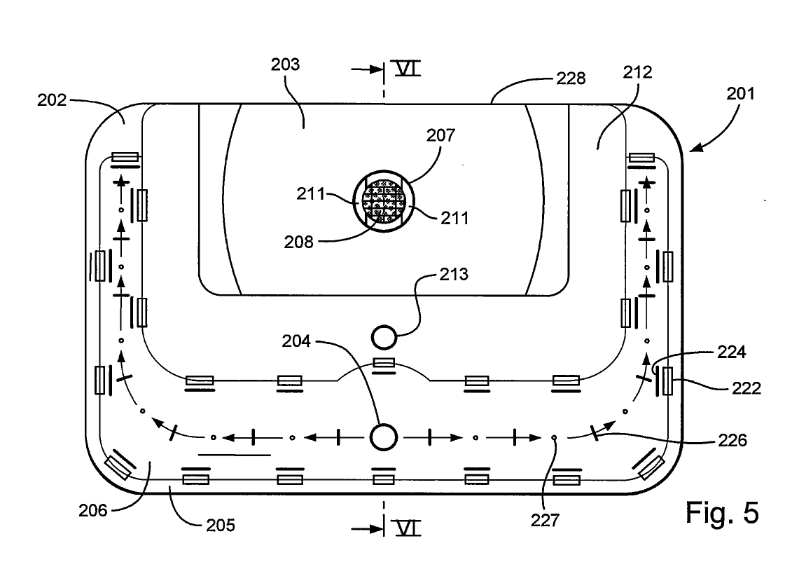

Baffles 126 and or dimples 127 (FIG. 5) may be present at the bottom of the channel 106.

Referring back to FIG. 2, in use, fuel vapour from the fuel tank (not shown), passes through the inlet 104 and into the distribution chamber 105 of the apparatus 101. The vapour will then flow down into the channel 106 in the distribution chamber 105 and around said channel 106 (3600). Once the channel 106 is full, further fuel vapours that enter into the channel 106 via the inlet 104 displace vapour already within the channel 106 over the sides and through the slots 122.

The fuel vapour will then flow down substantially evenly through the distribution chamber 105 from each and every slot 122. The vapour will flow through the spaces in the screen holder 123, through the screen 116 and into the first chamber 102 over a major portion of the surface of the adsorbent in the first chamber 102. The area of the screen holder 123 in contact with the carbon granules in the first chamber 102 having greater than the area of the screen 115 in contact with the carbon granules in the purge buffer 112.

The hydrocarbon molecules in the fuel vapour will adsorb onto the surfaces of the carbon granules that are within the first chamber 102. Circumferential substantially uniform adsorption should take place around the first chamber 102. During the course of “loading”, the vapour will pass downwardly through the first chamber 102 through carbon granules which have become saturated, to reach carbon granules available for adsorption.

Vapour will flow through saturated carbon granules and through the air space 118 to the carbon in the second chamber 103, where hydrocarbons will adsorb onto the surface of any available carbon granules. The vapour moves downwardly because it is denser than air (approximately 2.4 times denser) and once it has reached the bottom of apparatus 101, new vapour entering the first chamber 102 displaces the fuel vapour at the bottom of the apparatus 101 and forces it up into the second chamber 103.

A carbon monolith 108 is provided in the upper portion of the second chamber. Therefore in the event that the entirety of the carbon granules within both the first and second chambers 102 and 103 becomes saturated, the fuel vapours will move up from the lower portion of the second chamber 103 and through the carbon monolith 108. The hydrocarbon molecules in the fuel vapours are adsorbed in the carbon monolith 108, reducing the emission of harmful vapours through the vent 107 and into the atmosphere.

Typically a major portion of the carbon bed will become saturated with hydrocarbons if the engine is not used for approximately 2 days, although this will depend on ambient temperature.

When the engine is running under suitable conditions the apparatus 101 is purged.

In particular, during purging the inlet 104 is closed and the purge valve 113 is opened. A vacuum from the inlet manifold of the engine (not shown) is applied to the purge chamber 114 through the purge valve 113. This draws air downwardly into the vent 107, into the second chamber 103 and through into the first chamber 102. The hydrocarbons undergo desorption from the carbon granules in both the first chamber 102 and the second chamber 103 and are drawn with the air through the purge buffer 112, through the purge chamber 114 and out via the purge valve 113 to be burnt in the engine. This reduces the amount harmful vapours that are being released into the atmosphere. The purge buffer 112 inhibits vapour from the distribution chamber 105 being drawn directly into the inlet manifold.

The purge valve 113 is controlled by the controller in response to various parameters including the vacuum in the inlet manifold and the temperature in the catalytic converter in the exhaust line. Its degree of opening can also be adjusted, for example to inhibit a relatively large quantity of hydrocarbons being introduced into the engine when the carbon granules are saturated with hydrocarbon and/or the engine is cold.

Whilst the description so far has concerned vapour, another problem is that liquid from the fuel tank can enter the apparatus 101, particularly during hard cornering, hard braking, enthusiastic acceleration and when driving exuberantly over rough terrain. Unfortunately, if liquid fuel contacts the carbon granules it degrades their performance.

The channel 106 not only acts to evenly distribute the fuel vapour onto the surface of the carbon granules of the first chamber 102, but it also acts as a liquid trap.

As better shown in FIG. 3 or 4, any liquid fuel that enters the apparatus 101 and the distribution chamber 105 falls into the channel 106. This is particularly because the apparatus 101 is positioned in the upright position in order to function effectively. The channel 106 retains liquid within its sides and inhibits liquid from coming into contact with the carbon granules within the first and second chambers 102 and 103.

The shields 124 (FIG. 4) which can either be integral parts of the channel 106 or separate pieces and fixed thereto are provided in front of the slots 122, to inhibit any liquid retained within the channel 106 from splashing up and escaping through the slots 122. Alternatively the shields 124 could be a single continuous shield that extends the circumference of the top of both of the sides of the channel 106.

Baffles 126 and/or dimples 127, 327 (FIG. 5) reduce sloshing and splashing of any potential liquid retained within channel 106. This further reduces the probability of any liquid escaping out of the channel 106.

The slots 122 are approximately of an area of 12 mm² which varies depending on their position in the channel 106 (applicable to any shape of slot, which term includes hole). Therefore if any liquid was to escape through slots 122, the amount would be minimal and the screen 116 would be able to absorb the liquid, inhibiting it from reaching the carbon.

The first chamber 102 and the second chamber 103 are typically made in separate injection moulding machines. The apparatus 101 is assembled in a separate apparatus (typically by a robot). The second chamber 103 is welded in place.

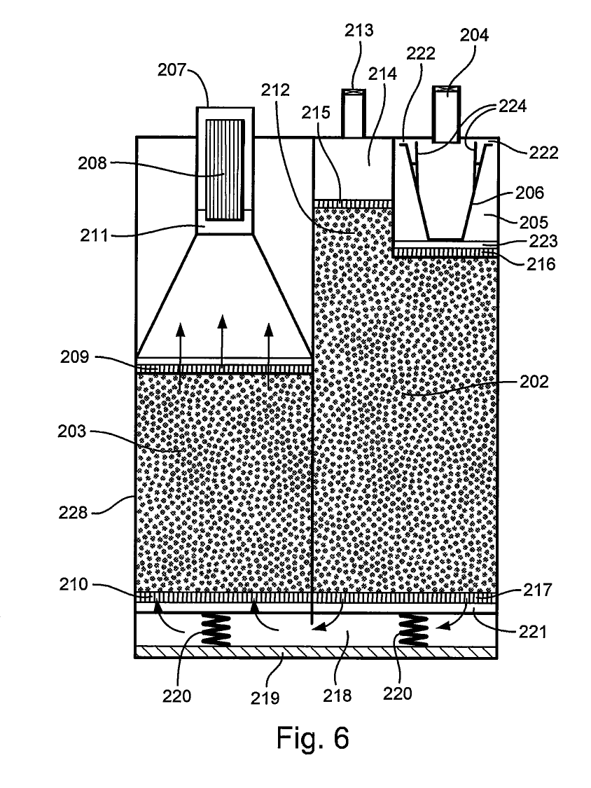

Referring to FIGS. 5 and 6, there is shown an apparatus for reducing hydrocarbon emissions from vehicles in accordance with a second embodiment of the present disclosure. The apparatus, which is generally identified by reference numeral 201, comprises a first chamber 202 and a second chamber 203, which is within the first chamber 202. The second chamber 203 is rectangular and is offset from the centre of the first chamber 202, so that one outer side of the second chamber 203 is in contact with one inner side 228 of the first chamber 202.

Both chambers 202 and 203 are substantially rectangular in horizontal cross section and both contain carbon granules.

The apparatus 201 further comprises an inlet 204 (from the fuel tank) and a distribution chamber 205 containing a distributor in the form of a channel 206, which extends around the distribution chamber 205. The channel 206 at the point closest to the inlet 204 is optionally provided with a curved section, on either side or both sides of the channel 206.

The apparatus 201 further comprises a vent 207 and a carbon monolith 208 within the upper portion of the second chamber 203. The carbon granules in the second chamber 203 fill only the lower portion of that chamber 203 and are retained by screens 209 and 210 which are permeable to vapour. The carbon monolith 208 is held in place with a support 211.

A purge buffer 212 containing carbon granules is in series with the carbon in the first chamber 201. The purge buffer 212 is separated from a purge valve 213 by a purge chamber 214 and a screen 215 that lays on top of the purge buffer 212.

The purge buffer 212 extends around the second chamber 203 in the shape of a “horseshoe” or “the three sides of a rectangle”, due to the positioning of the second chamber 203 within the first chamber 202. The ends of the “horseshoe” of the purge buffer 212 are in contact with the side 228. The distribution channel 205 and channel 206 therein extend around the purge buffer 212, also in a similar “horseshoe” shape.

The carbon granules in the first chamber 201 are retained by screen 216 and screen 217.

The bottom of both the first chamber 202 and the second chamber 203 are connected by an air space 218, which allows fuel vapour to move between the first chamber 202 and the second chamber 203. In assembly a base 219 is fitted to the bottom of the first chamber 203 which seals the apparatus 201. Springs 220 and a plate 221 are also provided to hold the components of the apparatus 201 in place.

The channel 206 comprises slots 222 positioned periodically around the top of the sides of the channel 206 and between the ceiling of the distribution chamber 205 and the top of the sides of the channel 206. The slots 222 penetrate through the channel 206 and the slots 222 are typically rectangular in shape, however could be circular or any shape.

The channel 206 sits upon a screen holder 223 of which it may be fixed thereon, alternatively the channel 206 and the screen holder 223 may be a single piece. The screen 216 is held in place by the screen holder 223, so that the screen 216 is in direct contact with the carbon granules and retains them within the first chamber 202.

The slots 222 are not of uniform size. In particular, they increase in length progressively as they move away from the inlet 204 around the channel 206. Alternatively the slots 222 could be of uniform size, or they could be of uniform size and the density of the slots 222 could increase as they move away from the inlet 204 around the channel 206. The slots 222 could be formed form a recess in the channel 206 and the ceiling of the distribution chamber 205.

The channel 206 is provided with the following optional separate and distinct features. Shields 224 are provided on the inside of the sides of the channel 206 in front of the slots 222. The shields 224 can either be integral parts of the channel 206 or separate pieces and fixed thereto, or a single continuous shield that extends the circumference of the top of both of the sides of the channel 206. Additionally baffles 226 and/or dimples 227 may be present at the bottom of the channel 206.

The first chamber 202 and second chamber 203 can be fabricated as a single injection moulding. The apparatus 201 is significantly less expensive to manufacture in comparison to the apparatus 101. This is because fewer machines are required for injection moulding and assembly. Additionally the differences in welding between the apparatuses 101 and 201 reduce the cost, namely there is no complicated sealing welding process required between the first 202 and second 203 chamber (which is required in apparatus 101) because they are moulded together from one piece.

A further advantage is that the apparatus 201 is more versatile in its design in that its shape and size can easily be changed to fit in different spaces.

In use the apparatus 201 functions in a similar way as previously described for the first embodiment of the present disclosure.

It should be noted that any of features can be used in any combination, between the first and second embodiments of the present disclosure.

In one non-limiting embodiment, with reference to FIGS. 2, 3 and 4, the apparatus is of the order of 235 mm in height and 140 mm in diameter. The volume of the first chamber 102 is approximately 1.8 Litres (0.0018 m³) and the volume of the second chamber is approximately 0.3 Litres (0.0003 m³). In certain non-limiting embodiments, the chambers 102 and 103 are manufactured from plastics material, such as (but not limited to), nylon or similar fuel resistant material. The channel 106 is approximately 35 mm in height, 15 mm in base width, the sides of the channels are approximately 35.5 mm in length and at an angle of approximately 90 from the base of the channel 106. In certain non-limiting embodiments, the channel 106 is manufactured from plastics material, such as (but not limited to), nylon or similar fuel resistant material.

The carbon monolith is approximately 100 mm in length and 30 mm in diameter. In certain non-limiting embodiments, the support 111 is approximately 10 mm in length and 40 mm in diameter and manufactured, such as (but not limited to), from an elastomeric material or plastics material.

The screen 115 is approximately 4000 mm² in surface area, which is the same size as the area of the top of the purge buffer 112. The screen 116 is approximately 10200 mm² in surface area, which is the same size as the area of the top of the carbon in the first chamber 102. Screen 117 is approximately 11600 mm² in surface area. Screens 109 and 110 have a surface area of approximately 3700 mm². Screens 109,110, 115, 116 and 117 are manufactured from non-woven fabric polyester material. The plate 121 is approximately 8 mm in thickness, covers a surface area equal to that of screen 117 and is manufactured from plastics material. The plate 121 is provided with holes to allow fuel vapour to pass through it. The springs 120 typically are manufactured from spring wire steel and are 15 mm in length.

The slots 122 are approximately 1.5 mm in width, and the length of the slots 122 range from 8 mm to 10 mm. The screen holder 123 is approximately 30 mm wide within the channel 105. The shields 124 are approximately 5 mm in height and extend the length of an individual slot 122. The web supports 125 are typically 18 mm in height and 4 mm in width. The baffles 126 are approximately 5 mm in height and 8 mm in length. The dimples 127 are approximately 8 mm in height and 3 mm in diameter. It should be noted that these dimensions can vary depending on the volume of the apparatus 101, 201 and the size of the engine of the vehicle and fuel tank.

The above components (shields 124, web supports 125, baffles 126 and dimples 127) are manufactured from plastics material.

In the second embodiment, with reference to FIGS. 5 and 6, the apparatus is of the order of 235 mm in height, 160 mm in width and 100 mm in depth. The volume of the first chamber 202 is approximately 1.8 Litres (0.0018 m³) and the volume of the second chamber 203 is approximately 0.3 Litres (0.0003 m³). In certain non-limiting embodiments, the chambers 202 and 203 are manufactured from plastics material, such as (but not limited to), nylon or similar fuel resistant material. The channel 206 is approximately 35 mm in height and 20 mm in base width, the sides of the channels are approximately 35.8 mm in length and at an angle of approximately 120 from the base of the channel 206. In certain non-limiting embodiments, the channel 206 is manufactured from plastics material, such as (but not limited to), nylon or similar fuel resistant material.

The carbon monolith is approximately 100 mm in length and 30 mm in diameter. In certain non-limiting embodiments, the support 211 is approximately 10 mm in length and 40 mm in diameter and manufactured, such as (but not limited to), from an elastomeric material or plastics material.

The screen 215 is approximately 4000 mm² in surface area, which is the same size as the area of the top of the purge buffer 212. The screen 216 is approximately 7300 mm² in surface area, which is the same size as the area of the top of the carbon in the first chamber 202. Screen 217 is approximately 11300 mm² in surface area. Screens 209 and 210 have a surface area of approximately 3760 mm². These screens 215, 216, 217, 209 and 210 are also manufactured from non-woven fabric polyester material.

The plate 221 is approximately 360 mm in length, 45 mm in width and 10 mm in thickness, in order to fit within the chambers 202, 203 and support screens 217, 210. It covers a surface area approximately equal to that of screens 217, 210 and is manufactured from plastics material. The plate 221 is provided with holes to allow fuel vapour to pass through it. It is possible for the plate 221 to comprise multiple plates, to separately support screens 217, 210. The springs 220 typically are manufactured from spring wire steel and are 15 mm in length.

The slots 222 are approximately 2.5 mm in width, and the length of the slots 222 range from 5 mm to 10 mm. The screen holder 223 is approximately 40 mm wide within the channel 205. The shields 224 are approximately 5 mm in height and extend the length of an individual slot 222. The web supports 225 are typically 5 mm in height and 10 mm in width. The baffles 226 are approximately 5 mm in height and 5 mm in length. The dimples 227 are approximately 8 mm in height and 4 mm in diameter. It should be noted that these dimensions can vary depending on the volume of the apparatus 101, 201 and the size of the engine of the vehicle and fuel tank.

The above components (shields 224, web supports 225, baffles 226 and dimples 227) are manufactured from plastics material.

The carbon granules are approximately of the order of 2.2 mm in mean diameter for pellet carbon and approximately 1.3 mm in mean diameter for granular carbon. However the actual sizes may vary depending on the particular use of the apparatus 101, 201 (e.g. the pressure loss requirements).

The size of the fuel tank that the apparatus 101, 201 may be used in conjunction which can range from approximately 20 litres to 80 litres, such as (but not limited to), 40 litres to 50 litres. However the apparatus may be used with other vehicles and their correspondingly sized fuel tanks, if the dimensions of the apparatus, carbon granule volumes and carbon grades are modified accordingly.

Various modifications to the embodiments described are envisaged, for example the apparatus 101, 201 (and components therein) could be manufactured out of other materials such as nylon 66, or metal where appropriate. The first and second chambers 102, 201 and 103, 203 could be different shapes, sizes, the sides of the chambers could be tapered or curved. The position of the second chamber 103, 203 could vary in relation to the first chamber 102, 202. The first and second chambers 102, 201 and 103, 203 could sit next to each other, or the second chamber 103, 203 could partly be within the first chamber 102, 201 and partly outside of it. Alternatively the second chamber 103, 203 may not necessarily pass through the entire length of the first chamber 102, 201, but a portion of it.

The volumes of the first 102, 202 and second 102, 202 chambers could vary. The volumes of the distribution chamber 105, 205 and the purge chamber 114, 214 could vary.

The channel 106, 206, could be modified to be a different size or shape in cross section, such as square, rectangular, semi-circular, triangular or “V” shaped. The channel 106, 206, could be modified to be a different size or shape in its top view layout within the distribution chamber such as elliptical, triangular, square, rectangular or “V” shaped.

The channel 106, 206 could be manufactured with the first and second chambers 102, 202, 103, 203 in the injection moulding process, together as a single piece. Additional pieces may have to fixed (e.g. welded) to the apparatus 101, 201, such as a top cover for the apparatus 101, 201.

The carbon monolith 108, 208 could be a different shape or size, or it could have a different structure, or omitted entirely. The support 111, 211 could be a different shape or size or omitted entirely or manufactured from any suitable material.

The screens, 109, 209, 110, 210, 115, 215, 116, 216, 117 and 217 could be different in shape, thickness, and/or could be manufactured from any other suitable material (e.g. a non-woven fabric material).

The slots 122, 222 could vary in size or shape, or their position in relation to the channel 106, 206, the distribution chamber 105, 205, or the screen holder 123, 223.

A tray or series of cups may be provided under the slots 122, 222 in order to catch and liquid that passes through the slots 122, 222, further reducing the probability of any liquid contacting the carbon granules (or pellets).

The plates 121, 221 could comprise multiple plates which may be separate and separately support the screens 110, 117, 210, 217. In particular the plate 221 could be formed of a U shaped plate to support the screen 217 of the first chamber 202 and a second plate positioned in the available gap within the U shaped plate to support the screen 210 of the second chamber 203. The two plates may substantially form a rectangle when fitted together.

The screen holder 123, 223 could vary in its structure, the spaces in it and in which fuel vapours pass through, could be different sizes or arranged in a different pattern. The screen holder 123, 223 could be fixed to the channel 106, 206, or manufactured as a single piece together, or the channel 106, 206 could simply rest upon the screen holder 123, 223.

The shields 124, 224 could be of any shape or size, fixed to the channel 106, 206 or manufactured together as a single piece. The shields 124, 224 alternatively could extend around both sides of the entire channel 106, 206, as one continuous shield.

The web supports 125, 225 could vary in shape or size, fixed to the channel 106, 306 or manufactured together as a single piece. The web supports 125, 225 alternatively could extend around both sides of the entire channel 106, 306, as two continuous web supports.

The baffles 126, 226 and/or dimples 127, 227 could vary in shape, size or number and be fixed to the channel 106, 206 or manufactured together as a single piece.

The process in which the components are fixed together could be by stake welding, or glue, or any other process known in the art, or pieces could be manufactured or moulded together as a whole.

Further various modifications to the embodiments described are envisaged. For example, if the problem of liquid fuel entering the first chamber 102, 202 is disregarded, the channel 106, 206 could be replaced by a perforate disk with perforates shaped, sized and disposed so that vapour entering the inlet would be substantially uniformly distributed over the surface of the carbon in the first chamber 102, 202.

The carbon granules used in the first 102, 202 and second 102, 202 chambers are typically activated carbon, for example as supplied under the trade mark NUCHAR® BAX 1100 and NUCHAR® BAX 1500 by Mead Westvaco.

The carbon monolith 108, 208, for example can also be supplied by Mead Westvaco.
1. Apparatus
2. First chamber
3. Second chamber
4. Fuel tank inlet
5. Distribution chamber
6. Ring
7. Slot
8. Air space
9. Spring
10. Plate
11. Purge chamber
12. Vent
13. Purge buffer
14. Purge valve
101. Apparatus
102. First chamber
103. Second chamber
104. Inlet
105. Distribution chamber
106. Channel
107. Vent
108. Carbon monolith
109. Screen
110. Screen
111. Support
112. Purge buffer
113. Purge valve
114. Purge chamber
115. Screen
116. Screen
117. Screen
118. Air space
119. Base
120. Springs
121. Plate
122. Slots
123. Screen holder
124. Shields
125. Webs supports
126. Baffles
127. Dimples
201. Apparatus
202. First chamber
203. Second chamber
204. Inlet
205. Distribution chamber
206. Channel
207. Vent
208. Carbon monolith
209. Screen
210. Screen
211. Support
212. Purge buffer
213. Purge valve
214. Purge chamber
215. Screen

1. An apparatus for reducing hydrocarbon emissions from vehicles, the apparatus comprising a first chamber for accommodating an adsorbent, a second chamber for accommodating an adsorbent, an inlet which allows vapor from a fuel tank to be introduced into said first chamber, and a distributor which, when said apparatus is in use and said first chamber and said second chamber contain adsorbent, and said inlet is connected to a fuel tank, distributes vapor from said fuel tank generally uniformly over a major portion of the surface of the adsorbent in said first chamber.

2. The apparatus of claim 1, wherein said distributor comprises a channel.

3. The apparatus of claim 2, wherein said channel comprises slots.

4. The apparatus of claim 3, wherein said slots are positioned above the base of the channel.

5. The apparatus of claim 3, wherein said slots increase in size progressively as they move away from the inlet around the channel.

6. The apparatus of claim 2, wherein said channel is provided with at least one shield.

7. The apparatus of claim 6, wherein said at least one shield protects at least one slot.

8. The apparatus of claim 2, wherein said channel comprises at least one web support.

9. The apparatus of claim 2, wherein said channel is provided with at least one baffle.

10. The apparatus of claim 9, wherein said baffle is positioned within the channel.

11. The apparatus of claim 9, wherein said baffle is positioned on the base of the channel.

12. The apparatus of claim 2, wherein said channel comprises at least one dimple to inhibit, in use, free flow of liquid therealong.

13. The apparatus of claim 12, wherein said dimple is positioned within the channel.

14. The apparatus of claim 12, wherein said dimple is positioned on the base of the channel.

15. The apparatus of claim 2, wherein the base of the channel is impervious to liquid fuel.

16. The apparatus of claim 3, wherein at least one of said slots is defined by a recess in the top of the channel.

17. The apparatus of claim 1, wherein the second chamber resides within the first chamber.

18. The apparatus of claim 17, wherein the second chamber is offset from the centre of the first chamber.

19. The apparatus of claim 17, wherein at least one side of the second chamber is in contact with at least one side of the first chamber.

20. The apparatus of claim 17, wherein at least one outer side of the second chamber is in contact with at least one inner side of the first chamber.

21. An apparatus for reducing hydrocarbon emissions from vehicles, the apparatus comprising a first chamber for accommodating an adsorbent and a second chamber for accommodating an adsorbent, wherein the second chamber resides within the first chamber and the second chamber is offset from the centre of the first chamber.

22. The apparatus of claim 21, wherein at least one side of the second chamber is in contact with at least one side of the first chamber.

23. The apparatus of claim 21, wherein at least one outer side of the second chamber is in contact with at least one inner side of the first chamber.

24. The apparatus of claim 21, wherein, in use, the horizontal cross section of at least one of the first chamber and the second chamber is substantially rectangular.

25. A vehicle having a fuel tank connected to an apparatus as claimed in claim 1.
